(19) United States
(12) Patent Application Publication
(10) Pub. No.: US 2011/0154376 A1
(43) Pub. Date: Jun. 23, 2011

(54) Use of Web Services API to Identify Responsive Content Items

(75) Inventors: Ashish Consul, Redmond, WA (US); Suryanarayana M. Gorti, Redmond, WA (US)

(73) Assignee: MICROSOFT CORPORATION, Redmond, WA (US)

(21) Appl. No.: 12/640,935

(22) Filed: Dec. 17, 2009

(51) Int. Cl. G06F 9/44

(52) U.S. Cl. 719/328

(57) ABSTRACT

A web services request is sent to a server via a network. The server provides a web services API that includes a method that operates to identify responsive content items among a plurality of content items. The plurality of content items is partitioned into a plurality of folders. The plurality of folders is divided into a plurality of hierarchical sets of folders. Each of the hierarchical sets of folders is associated with a different user in a plurality of users. The web services request requests invocation of the method. The responsive content items are ones of the content items that satisfy a specified query condition and that are in a specified one of the folders. A web services response is received from the server in response to the web services request. The web services response specifies one or more properties of at least one of the responsive content items.

### BACKGROUND

Individuals can receive and generate dozens of e-mail messages a day. Because many of these e-mail messages contain important information, individuals store many of the e-mail messages they receive. As individuals store more e-mail messages, it becomes progressively more difficult for a user to find a desired e-mail message. To make it easier to find desired e-mail messages, various search tools have been developed. The search tools identify e-mail messages containing search strings provided by individuals.

To improve response times, the search tools create indexes. The indexes are data structures that map terms to e-mail messages that contain the terms. To create an index, a search tool retrieves individual e-mail messages from an e-mail server where the e-mail messages are stored. The search tool parses each of the e-mail messages and creates entries in the index based on the content of the e-mail messages. The index is typically stored at the computing device where the search tool operates.

In an enterprise setting, separate search tools operate on each employee's computing device. In addition, some enterprises maintain websites that allow individuals to search for e-mail messages. Search tools also operate on server devices that host such websites. The search tools create separate indexes on each employee's computing device and on the server devices. Because each of the search tools creates an index by retrieving e-mail messages from the e-mail server, the creation and subsequent maintenance of the indexes can present a significant load on the e-mail server, employees' computing devices, and the servers.

Similar search tools have been created for other types of content items for similar reasons and operate in similar ways. Example types of content items aside from e-mail messages include calendar appointments, contacts, journal entries, task entries, and so on.

### SUMMARY

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

In one aspect, a method comprises sending, by a computing system, a web services request to a server via a network. The server provides a web services application programming interface (API) that includes a method that operates to identify responsive content items among a plurality of content items. The plurality of content items is partitioned into a plurality of folders. The plurality of folders is divided into a plurality of hierarchical sets of folders. Each of the hierarchical sets of folders is associated with a different user in a plurality of users. Each of the content items is a set of properties representing personal information. The web services request requests invocation of the method. The responsive content items are ones of the content items that satisfy a query condition and that are in a folder in the plurality of folders. The web services request comprises an element that specifies the folder. The web services request comprises an element that expresses the query condition. The web services request comprises an element that identifies requested ones of the properties of the content items to return. In addition, the method comprises receiving, by the computing system, a web services response from the server. The web services response specifies the requested ones of the properties of at least one of the responsive content items.

In another aspect, a method comprises receiving, by a computing system, a web services request from a client computing system via a network. The computing system provides a web services API that includes a method. The web services request requests invocation of the method. The web services request comprises an element that specifies a folder. The web services request comprises an element that expresses a query condition. The web services request comprises an element that identifies requested properties of content items to return. Furthermore, the method comprises, in response to receiving the web service request, using an indexing service to identify responsive content items among a plurality of content items. Each of the content items is a set of properties representing personal information. The plurality of content items is partitioned into a plurality of folders that includes that specified folder. The plurality of folders is partitioned into a plurality of hierarchical sets of folders. Each of the hierarchical sets of folders is associated with a different user in a plurality of users. The responsive content items are ones of the content items that satisfy the query condition and that are in the specified folder. The method also comprises sending, by the computing system, a web services response to the client computing system. The web services response specifies the requested properties of at least one of the responsive content items.

In yet another aspect, a computer-readable data storage medium comprises software instructions that, when executed by a processing unit of a computing system, cause the computing system to receive, by a client application that assists in e-discovery by searching a plurality of folders, input expressing one or more query conditions. In addition, the software instructions cause the computing device to receive an invocation of a method of a client API from the client application. Furthermore, the software instructions cause the computing device to send, in response to receiving the invocation of the method of the client API, a web services request to a server via a network. The server provides a web services API that includes a method that operates to identify responsive content items among a plurality of content items. The plurality of content items is partitioned into the plurality of folders. The plurality of folders is divided into a plurality of hierarchical sets of folders. Each of the hierarchical sets of folders is associated with a different user in a plurality of users. Each of the content items is a set of properties representing personal information. The web services request requests invocation of the method. The responsive content items are ones of the content items that satisfy the one or more query conditions and that are in a folder in the plurality of folders. The web services request comprises an element that specifies the folder. The web services request comprises an element that expresses the one or more query conditions as an Advanced Query Syntax (AQS) query string. The web services request comprises an element that identifies requested ones of the properties of the content items to return, an element that expresses a way in which the responsive content items are to be formatted, an element that expresses a way in which the responsive content items are to be grouped, an element that expresses an order in which the responsive content items are to be sorted, and an element that expresses whether to search for responsive content items in sub-folders of the folder. The web services request is an extensible markup language (XML) document that conforms to one XML schema. The software instructions also cause the computing device to send an identification token to the web services API. The identification token identifies a user. Furthermore, the software instructions cause the computing device to receive a web services response from the server. The web services response specifies the requested ones of the properties of at least one of the responsive content items. The web services response is an XML document that conforms to another XML schema. The web services response only includes ones of the responsive content items that the user is authorized to access. In addition, the software instructions cause the computing device to return a software object that represents the at least one of the responsive content items to the client application.

### BRIEF DESCRIPTION OF THE DRAWINGS

FIG. 1 is a block diagram illustrating an example system in which a web services application programming interface (API) is used to identify responsive content items.

FIG. 2 is a flowchart illustrating an example operation of a client.

FIG. 3 is a flowchart illustrating an example operation of a client access server.

FIG. 4 is a block diagram illustrating a version of the system in which the client uses a federated search system to identify responsive content items.

FIG. 5 is a block diagram illustrating an example computing device usable in the system.

### DETAILED DESCRIPTION

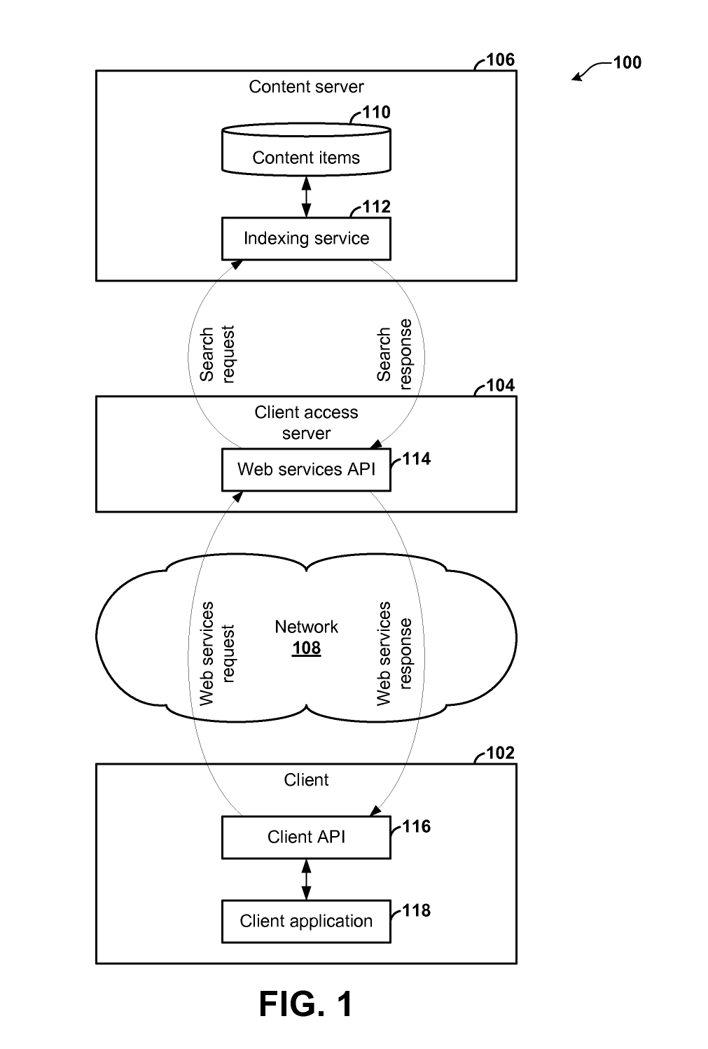

FIG. 1 is a block diagram illustrating an example system 100 in which a web services application programming interface (API) is used to identify responsive content items. The system 100 is merely one embodiment. Other embodiments include more or fewer computing devices, computing systems, networks, and other components.

As illustrated in the example of FIG. 1, the system 100 includes a client 102, a client access server 104, and a content server 106. The client 102, the client access server 104, and the content server 106 are computing systems. As used herein, a computing system is a system comprising one or more computing devices. A computing device is a device that computes information. In various embodiments, the client 102, the client access server 104, and the content server 106 can comprise various types of computing devices. For example, the client 102, the client access server 104, and/or the content server 106 can comprise personal computers, laptop computers, handheld computers, mobile telephones, television set top boxes, computing devices integrated into vehicles, game consoles, standalone server computing devices, server blade devices, mainframe computing devices, or other types of computing devices.

In the example embodiment of FIG. 1, the client access server 104 and the content server 106 are shown as separate computing systems. However, in other embodiments, a single computing device acts as both the client access server 104 and the content server 106.

The system 100 also includes a network 108. The network 108 is a collection of computing devices and links that facilitate communication between the client 102 and the client access server 104. In various embodiments, the network 108 includes various types of links, including wired links and/or wireless links. Furthermore, in various embodiments, the network 108 is implemented at various scales. For example, the network 108 can be implemented as a wide area network, a local area network, or a network implemented at another scale.

The content server 106 stores content items 110. A content item is a set of properties representing personal information. In various embodiments, the content items represent different types of personal information. For example, the content items 110 can represent e-mail messages, calendar entries, contacts, journal entries, task list entries, and other types of personal information. Different types of content items have different sets of properties. For example, in some embodiments, an e-mail message includes a “to” property, a “from” property, a “cc” property, a “bcc” property, a “subject” property, a “body” property, a “time sent” property, and so on. Furthermore, in some embodiments, a contact includes a “first name” property, a “last name” property, an “e-mail address” property, a “home telephone number” property, a “work telephone number” property, a “mailing address” property, and so on.

The content items 110 are partitioned into a plurality of folders. A folder is a logical structure that can contain content items. Each of the folders is identified by a folder identifier. The plurality of folders is divided into a plurality of hierarchical sets of folders. In some embodiments where the content items 110 are e-mail messages, each of the hierarchical sets of folders is referred to as a mailbox. For example, a mailbox can include an “inbox” folder containing received e-mail messages, and a “sent” folder containing previously sent e-mail messages. Furthermore, in this example, the “inbox” folder can contain a “personal” folder containing previously received e-mail messages related to personal matters and a “junk” folder containing junk e-mail messages. In some instances, a mailbox only includes a single folder. For ease of explanation, this disclosure refers to the hierarchical sets of folders as mailboxes, regardless of the type of the content items 110.

In some embodiments, each of the mailboxes is associated with a different user in a plurality of users. For example, one of the mailboxes may be associated with a user “Bob Jones,” another one of the mailboxes may be associated with a user “Sue Davis,” and another one of the mailboxes may be associated with an “Accounts Receivable Department.” In some instances, a single user can be associated with multiple ones of the mailboxes and a single one of the mailboxes can be associated with a single user.

In addition to storing the content items 110, the content server 106 provides an indexing service 112. The indexing service 112 generates and maintains an index to the content items in each of the mailboxes. The index is a data structure that comprises a set of entries. Each entry maps a term to one or more of the content items to which the term is applicable. For example, an entry can map the term “mascot” to content items that contain the term “mascot.” In another example, an entry in the index can map the term “2009” to content items created in the year 2009. In this other example, the content items created in the year 2009 do not necessarily need to include data specifying that they were created in the year 2009. An entry in the index can map a term to content items in multiple ones of the mailboxes. For example, an entry can map the term “team” to a content item in a mailbox associated with the user “Bob Jones” and to a content item in a mailbox associated with the user “Sue Davis.”

The client access server 104 provides a web services API 114. The web services API 114 includes at least a find items method. When invoked, the find items method uses the indexing service 112 of the content server 106 to identify and format responsive content items. The responsive content items are content items that satisfy query conditions specified by one or more parameters of the find items method and that are in one of the specified mailboxes.

In the example of FIG. 1, the client 102 includes a client API 116. The client API 116 is an API that includes at least a search method. When invoked, the search method generates a web services request and sends the web services request to the client access server 104 via the network 108. The web services request is a request to invoke the find items method of the web services API 114 provided by the client access server 104. The web services request comprises elements corresponding to at least some of the parameters of the find items method.

In addition, the client 102 includes a client application 118. The client application 118 invokes the search method of the client API 116 to find responsive content items. In various embodiments, the client application 118 can be a variety of different types of applications. For example, the client application 118 can be an e-mail client application, a calendar client application, the Microsoft OUTLOOK® messaging and collaboration client, a desktop search application, a web server, a federated search service, or another type of application.

In some embodiments, the client application 118 generates and sends the web services request to the client access server 104 via the network 108 without using the client API 116. However, in some embodiments, use of the client API 116 may simplify the task of designing the client application 118 because the client application 118 would not need to include code for generating and sending the web services request.

When the client access server 104 receives the web services request from the client 102, the client access server 104 invokes the find items method of the web services API 114. As discussed above, the find items method uses the indexing service 112 of the content server 106 to identify and format responsive content items in a specified one of the mailboxes. After identifying and formatting the responsive content items, the client access server 104 sends a web services response to the client 102. The web services response specifies at least some of the responsive content items in the specified mailbox.

In various embodiments, the web services request and the web services response are formatted in various ways. For example, in some embodiments, the web services request and the web services response are formatted as XML documents conforming to the SOAP protocol. In other embodiments, the web services request and the web services response are formatted in other markup languages, such as Standard Generalized Markup Language (SGML) or conform to other protocols, such as XML-RPC or WS-Addressing.

In various embodiments, the client application 118 performs various actions upon receiving the web services response. For example, in some embodiments, the client application 118 generates a web page listing the responsive content items specified in the web services response. The client application 118 then sends the web page to a computing device that originally requested the web page. In other embodiments, the client application 118 displays the responsive content items in the web services response on a graphical user interface.

The example of FIG. 1 only shows the client 102 as sending web services requests to the client access server 104. Nevertheless, some embodiments of the system 100 include a plurality of client devices that send web services requests invoking the find items method to the client access server 104. For example, in a large enterprise, the system 100 can include thousands of clients that can send web services requests invoking the find items method to the client access server 104. Because each of these clients uses the find items method of the web services API 114 to identify and format responsive content items, it may not be necessary for each of these clients to maintain a separate index of the content items 110.

In various embodiments, the indexing service 112, the web services API 114, the client API 116, and the client application 118 can be implemented in various ways. For example, in some embodiments, the indexing service 112, the web services API 114, the client API 116, and the client application 118 are implemented as sets of software instructions that, when executed by a processing unit, cause the content server 106, the client access server 104, and the client 102 to perform the activities ascribed herein to the indexing service 112, the web services API 114, the client API 116, and the client application 118. In such embodiments, the software instructions can be stored on computer-readable data storage media. In other embodiments, the content server 106, the client access server 104, and the client 102 include one or more application-specific integrated circuits that cause the content server 106, the client access server 104, and the client 102 to perform the activities ascribed herein to the indexing service 112, the web services API 114, the client API 116, and the client application 118.

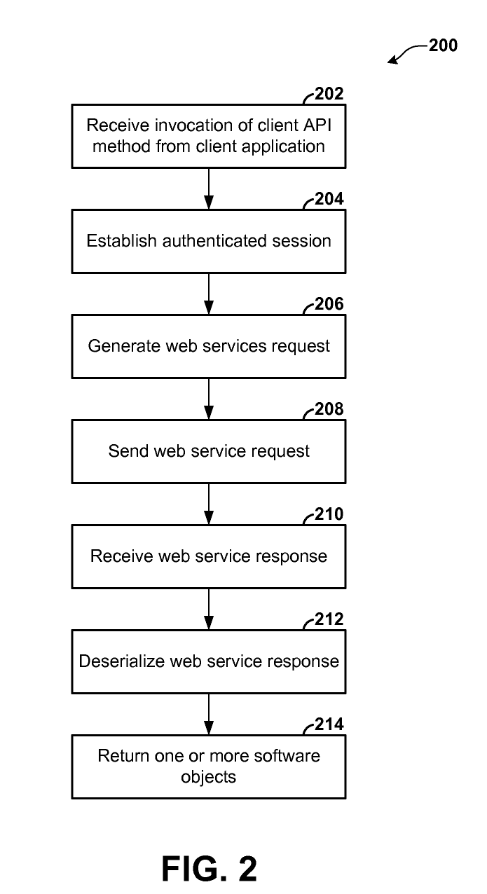

FIG. 2 is a flowchart illustrating an example operation 200 of the client 102. It should be appreciated that the client 102 performs the operation 200 in some embodiments. In other embodiments, the client 102 performs other operations. For example, the client 102 can perform operations including more or fewer steps or include the steps of the operation 200 in a different order.

As illustrated in the example of FIG. 2, the operation 200 begins when the client API 116 receives, from the client application 118, an invocation of a search method of the client API 116 (202). When the client API 116 receives the invocation of the search method, the client API 116 receives one or more parameters of the search method.

In various embodiments, the search method of the client API 116 has various parameters. For example, in some embodiments, the search method has a parent folder identifier parameter, a query string parameter, and an item view parameter. The parent folder identifier parameter specifies a folder identifier that identifies a folder in which to search for responsive content items. Because a mailbox is considered to be a root of a hierarchical set of folders, the entire mailbox can be searched when the parent folder identifier identifies the mailbox. The query string parameter specifies one or more query conditions as an Advanced Query Syntax (AQS) query string. AQS is a query syntax developed by MICROSOFT® Corporation. Responsive content items are content items in the folder specified by the parent folder identifier parameter that satisfy the AQS query string specified by the query string parameter. The item view parameter specifies which properties of the responsive content items to return and how the responsive content items are to be formatted. For example, where the content items are contacts, the item view parameter could specify that only a “last name” property and a “telephone number” property of responsive content items are to be returned and could specify that responsive content items are to be returned in pages of no more than ten content items.

In another example, the search method has a parent folder identifier parameter, a search filter parameter, and an item view parameter. In this other example, the parent folder identifier parameter and the item view parameter function similarly to the parent folder identifier parameter and the item view parameter of the previous example. However, in this example, the search filter parameter specifies one or more query conditions as a search filter object. The search filter object comprises a set of one or more name-value pairs that specify properties and values of the properties. Responsive content items are content items in the folder specified by the parent folder identifier parameter that have values of the properties specified by the search filter object specified by the query string parameter.

After receiving the invocation of the search method of the client API 116, the client 102 establishes an authenticated session with the client access server 104 (204). When the client 102 establishes the authenticated session with the client access server 104, the client 102 sends an identification token to the client access server 104. The identification token is a data structure that identifies a user. As described herein, the find items method of the web services API 114 only returns responsive content items that the user identified by the identification token is authorized to access. For example, a user “Jerry Smith” and a user “Jenny Jones” may be co-workers on a sales team. In this example, the user “Jerry Smith” may not be authorized to access content items associated with the user “Jenny Jones.” In some embodiments, users have different levels of access to content items. For example, some users are authorized to read, edit, and delete content items in a mailbox while other users are only authorized to read content items in the mailbox.

In some embodiments, the each of the users is assigned a role. A role is a function within an organization. For example, a user “Jerry Smith” can be assigned the role “receptionist,” a user “Jenny Jones” can be assigned the role “CEO,” and users “Nelson Chang” and “Liam Schmidt” can be assigned the role “electronic discovery.” Users with particular roles are authorized to access particular mailboxes. For example, users with the role “electronic discovery” can be authorized to access content items in multiple ones of the mailboxes (e.g., all of the mailboxes). Consequently, in this example, the user “Nelson Chang” and the user “Liam Schmidt” are authorized to access all mailboxes.

In some embodiments, the identification token is a data structure comprising a set of assertions. The assertions are statements about a user. For example, an assertion can indicate that a user's first name is “Jerry,” the user's last name is “Smith,” and the user's role is “receptionist.” The identification token is digitally signed by an identification authority.

In some circumstances, the identification token identifies a user who is logged in to the client 102. For example, the client 102 can be a personal computer used by the user “Jerry Smith.” In this example, the identification token can identify the user “Jerry Smith.”

In other circumstances, the identification token does not identify a user who is logged in to the client 102. Rather, the identification token indicates that the client 102 is acting as though a user was logged in to the client 102. In other words, the identification token is an impersonation token because the client 102 is impersonating a user who is not logged in to the client 102. For example, the client 102 can be a server that hosts a web site that can be used to search the content items 110. In this example, the user “Jerry Smith” uses a web browser on his personal computer to send a request for a web page containing responsive content items. In this example, the user “Jerry Smith” is only allowed to access content items that the user “Jerry Smith” is authorized to access. Accordingly, the client 102 (i.e., the web server) sends an identification token that identifies the user “Jerry Smith.” Because the find items method of the web services API 114 only returns responsive content items that the user identified by the identification token is authorized to access, the client 102 does not receive, and the user “Jerry Smith” cannot access, responsive content items that the user “Jerry Smith” is not authorized to access.

In some embodiments, a user is authorized to access content items in mailboxes associated with a plurality of users. For example, each user in an accounting department of an enterprise has a separate mailbox. In this example, a supervisor of the accounting department can be authorized to access the content items in the mailboxes associated with the users in the accounting department. In this way, the supervisor can check whether the users are using company resources for personal purposes. In another example, an enterprise authorizes a user to conduct electronic discovery (e-discovery) in connection with a lawsuit. In this example, the enterprise authorizes users having an “e-discovery manager” role to access content items in mailboxes of all users in a given class of users.

After the client 102 sends the identification token, the client API 116 generates a web services request (206). The web services request is a request to invoke the find items method of the web services API 114 at the client access server 104. After the client API 116 generates the web services request, the client API 116 sends the web services request to the client access server 104 via the network 108 (208).

In the example embodiment illustrated in FIG. 2, the web services request is an XML document conforming to the SOAP protocol. The web services request conforms to an XML schema that expresses constraints on the structure and content of XML documents conforming to the XML schema. In various embodiments, the web services request conforms to various XML schemas. For example, in some embodiments, the web services request conforms to the following XML schema:

<xs:complexType name=“FindItemType”>

<xs:complexContent>

<xs:extension base=“m:BaseRequestType”>

<xs:sequence>

<xs:element name=“ItemShape” type=“t:ItemResponseShapeType”/>
<xs:choice minOccurs=“0”>

<xs:element name=“IndexedPageItemView”

type=“t:IndexedPageViewType”/>

<xs:element name=“FractionalPageItemView”

type=“t:FractionalPageViewType”/>

<xs:element name=“CalendarView” type=“t:CalendarViewType”/>
<xs:element name=“ContactsView” type=“t:ContactsViewType”/>

</xs:choice>
<xs:choice minOccurs=“0”>

<xs:element name=“GroupBy” type=“t:GroupByType”/>
<xs:element name=“DistinguishedGroupBy”

type=“t:DistinguishedGroupByType”/>

</xs:choice>
<xs:element name=“Restriction” type=“t:RestrictionType”

minOccurs=“0”/>

<xs:element name=“SortOrder”

type=“t:NonEmptyArrayOfFieldOrdersType” minOccurs=“0”/>

<xs:element name=“ParentFolderIds”

type=“t:NonEmptyArrayOfBaseFolderIdsType”/>

<xs:element name=“QueryString” type=“xs:string” minOccurs=“0” />

</xs:sequence>
<xs:attribute name=“Traversal” type=“t:ItemQueryTraversalType”

use=“required”/>

</xs:extension>

</xs:complexContent>

</xs:complexType>
<xs:element name=“FindItem” type=“m:FindItemType”/>

In this example, this XML schema indicates that XML documents conforming to the XML schema are allowed to include “FindItem” elements having the “FindItemType” type. Furthermore, in this example, the XML schema indicates that elements having the “FindItemType” type include an “ItemShape” element having an “ItemResponseShapeType” type. The “ItemShape” element of a “FindItem” element expresses the set of properties of responsive content items to return. For example, where the content items are e-mail messages, the “ItemShape” element can specify that the “to” property and the “subject” property of e-mail messages, but not the “from” property or the “body” property of e-mail messages.

In addition, the XML schema indicates that elements having the “FindItemType” are allowed to include one of: an “IndexedPageItemView” element, a “FractionalPageItemView” element, a “CalendarView” element, or a “ContactsView” element. These elements express how the responsive content items are to be formatted. For example, when the web services request includes an “IndexedPageItemView” element, the web services API 114 formats the responsive content items such that the responsive content items are divided into a plurality of pages. The “IndexedPageItemView” element also specifies which one of the pages to return. When the web services request includes a “FractionalPageItemView” element, the web services API 114 formats the responsive content items such that the responsive content items are divided into groups. The “FractionalPageItemView” element also specifies one of the groups to return. Each of the groups has essentially the same number of responsive content items. For example, the “FractionalPageItemView” element can specify that the responsive content items are to be divided into four groups and that the third one of the groups is to be returned. When the web services request includes a “CalendarView” element, the web services API 114 formats the responsive content items such that the responsive content items are displayed in a calendar. When the web services request includes a “ContactsView” element, the web services API 114 formats the responsive content items such that the responsive content items are displayed as contacts.

In addition, the XML schema indicates that elements having the “FindItemType” are allowed to include one of: a “GroupBy” element or a “DistinguishedGroupBy” element. The “GroupBy” element and the “DistinguishedGroupBy” element express alternate ways to group responsive content items. For example, the “GroupBy” element or the “DistinguishedGroupBy” element can indicate that responsive content items are to be grouped by priority class. The XML schema also indicates that elements having the “FindItemType” are allowed to include a “SortOrder” element. The “SortOrder” element expresses an order in which to sort responsive content items. For example, the “SortOrder” element can indicate that the responsive content items are to be sorted alphabetically.

Furthermore, the XML schema indicates that elements having the “FindItemType” are allowed to include a “Restriction” element. The “Restriction” element expresses a search filter object. As discussed above, a search filter object comprises a set of one or more name-value pairs that specify properties and values of the properties. In addition, the XML schema indicates that elements having the “FindItemType” are allowed to include a “QueryString” element. The “QueryString” element expresses an AQS query string. The AQS query string expresses one or more query conditions. In some embodiments, an error occurs when the web services request includes both a “Restriction” element and a “QueryString” element.

In addition, the XML schema indicates that elements having the “FindItemType” include a “ParentFolderIds” element. The “ParentFolderIds” element expresses one or more folder identifiers that identify folders in which to search for responsive content items. Furthermore, the XML schema indicates that elements having the “FindItemType” include a “Traversal” attribute. The “Traversal” attribute expresses whether to search for responsive content items in sub-folders of the folders identified by the “ParentFolderIds” element.

After the client API 116 sends the web services request to the client access server 104, the client API 116 receives a web services response from the client access server 104 via the network 108 (210). The web services response is responsive to the web services request. If there are any responsive content items in the folders identified by the web services request, the web services response comprises one or more properties of the responsive content items.

In the example embodiment illustrated in FIG. 2, the web services response is an XML document conforming to the SOAP protocol. The web services response conforms to an XML schema that expresses constraints on the structure and content of XML documents conforming to the XML schema. In various embodiments, the web services response conforms to various XML schemas. For example, in some embodiments, the web services response conforms to the following XML schema:

<xs:complexType name=“ResponseMessageType”>

<xs:sequence minOccurs=“0”>

<xs:element name=“MessageText” type=“xs:string”
minOccurs=“0”/>
<xs:element name=“ResponseCode”
type=“m:ResponseCodeType”

minOccurs=“0”/>

<xs:element name=“DescriptiveLinkKey” type=“xs:int”
minOccurs=“0”/>
<xs:element name=“MessageXml” minOccurs=“0”>

<xs:complexType>

<xs:sequence>

<xs:any processContents=“lax” minOccurs=“0”

maxOccurs=“unbounded”/>

</xs:sequence>

</xs:complexType>

</xs:element>

</xs:sequence>
<xs:attribute name=“ResponseClass” type=“t:ResponseClassType”

use=“required”/>

</xs:complexType>
<xs:complexType name=“FindItemResponseMessageType”>

<xs:complexContent>

<xs:extension base=“m:ResponseMessageType”>

<xs:sequence>

<xs:element name=“RootFolder”
type=“t:FindItemParentType”

minOccurs=“0”/>

</xs:sequence>

</xs:extension>

</xs:complexContent>

</xs:complexType>
<xs:complexType name=“ArrayOfResponseMessagesType”>

<xs:choice maxOccurs=“unbounded”>

. . .
<xs:element name=“FindItemResponseMessage”

type=“m:FindItemResponseMessageType”/>

. . .

</xs:choice>

</xs:complexType>
<xs:complexType name=“BaseResponseMessageType”>

<xs:sequence>

<xs:element name=“ResponseMessages”

type=“m:ArrayOfResponseMessagesType”/>

</xs:sequence>

</xs:complexType>
<xs:complexType name=“FindItemResponseType”>

<xs:complexContent>

<xs:extension base=“m:BaseResponseMessageType”/>

</xs:complexContent>

</xs:complexType>
<xs:element name=“FindItemResponse”
type=“m:FindItemResponseType”/>

In this example, the XML schema indicates that XML documents conforming to the XML schema are allowed to include “FindItemResponse” elements having the “FindItemResponseType” type. Furthermore, in this example, the XML schema indicates that the “FindItemResponseType” type extends the “BaseResponseMessageType.” The XML schema also indicates that elements having the “BaseResponseMessageType” include a “ResponseMessages” element having an “ArrayOfResponseMessageType” type. The XML schema indicates that elements having the “ArrayOfResponseMessageType” type can include a “FindItemResponseMessage” element having a “FindItemResponseMessageType” type. The “FindItemResponseMessageType” type extends the “ResponseMessageType” by adding a sequence of “RootFolder” elements. Elements having the “ResponseMessageType” can include a “MessageText” element, a “ResponseCode” element, a “DescriptiveLinkKey” element, and a “MessageXml” element. The “MessageXml” element can include a sequence of any XML elements. The “MessageXml” element contains XML specifying the responsive content items.

After receiving the web services response, the client API 116 deserializes the web services response (212). Deserializing the web services response comprises generating one or more software objects representing one or more elements in the web services response. In various embodiments, the client API 116 deserializes the web services response in various ways. For example, in some embodiments, the client API 116 deserializes the web services response by creating a software object containing the web services response. In other embodiments, the client API 116 deserializes the web services response by creating a separate software object for each responsive content item in the web services response.

After deserializing the web services response, the client API 116 returns to the client application 118 the one or more software objects that result from deserializing the web services response (214). In various embodiments, the client API 116 returns various software objects to the client application 118. For example, where the client API 116 deserializes the web services response by creating a software object containing the web services response, the client API 116 returns a pointer to the software object. In another example, where the client API 116 deserializes the web services response by creating a separate software object for each responsive content item in the web services response, the client API 116 returns a pointer to an array containing the software objects for the responsive content items.

Although not illustrated in the example of FIG. 2 for purposes of clarity, the operation 200 can be repeated consecutive times with different web services requests. For example, the client application 118 can be designed to assist in e-discovery by automatically searching mailboxes associated with a plurality of designated users. In this example, the client application 118 repeatedly invokes the search method of the client API 116, specifying folder identifiers of each of the designated users. In this way, the client application 118 is able to search a large number of mailboxes without retrieving each of the content items 110 from the content server 106. Furthermore, in some embodiments, when the operation 200 is performed consecutive times, the client API 116 does not resend the identification token each time the client API 116 sends the web services request.

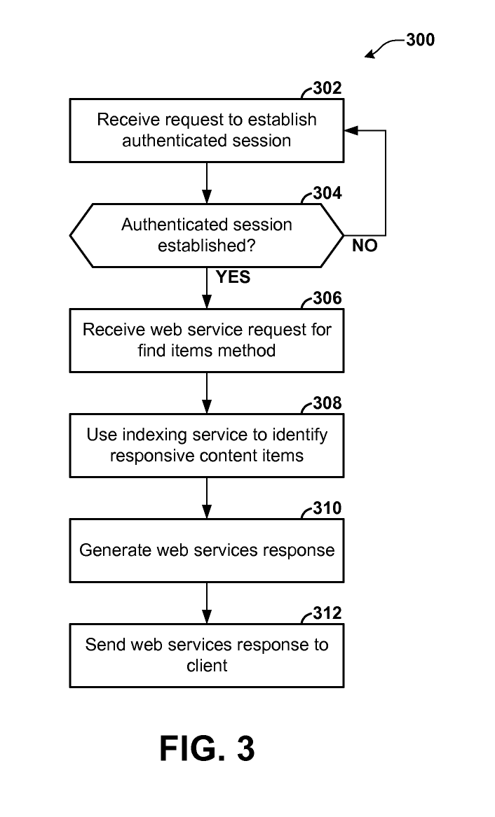

FIG. 3 is a flowchart illustrating an example operation 300 of the client access server 104. It should be appreciated that the web services API 114 performs the operation 300 in some embodiments. In other embodiments, the web services API 114 performs other operations. For example, the web services API 114 can perform operations including more or fewer steps or include the steps of the operation 300 in a different order.

As illustrated in the example of FIG. 3, the operation 300 begins when the client access server 104 receives a request from the client 102 to establish an authenticated session (302). During establishment of the authenticated session, the client access server 104 receives an identification token from the client 102. As described above, the identification token identifies a user. In various embodiments, the client access server 104 performs various actions when the client access server 104 receives the request to establish an authenticated session. For example, in some embodiments, the identification token includes a set of assertions that are digitally signed by an identification authority. In this example, the client access server 104 determines whether the client access server 104 trusts the identification authority. If the client access server 104 trusts the identification authority, the client access server 104 trusts the assertions in the identification token. Example assertions include a user's name, a user's role, a user's identification number, and so on.

Subsequently, the client access server 104 determines whether an authenticated session has been established with the client 102 (304). If the web services API 114 does not successfully verify the identification token (“NO” of 304), the web services API 114 waits to receive another identification token (302). If the web services API 114 successfully verifies the identification token (“YES” of 304), the web services API 114 is able to receive a web services request from the client 102 via the network 108 (306). The web services request is a request to invoke the find items method of the web services API 114. In some embodiments, the web services request is an XML document conforming to the XML schema discussed above.

The find items method takes a set of parameters. In various embodiments, the set of parameters includes various parameters. For example, in some embodiments, the set of parameters includes an item shape parameter, an indexed page view parameter, a fractional page item view parameter, a calendar view parameter, a contacts view parameter, a group by parameter, a restriction parameter, a sort order parameter, a parent folder identifier parameter, a query string parameter, and a traversal parameter. In this example, the web services request is an XML document conforming to the XML schema discussed above. Elements in the web services request correspond to one or more of the parameters of the find item method. Elements in the web services request are passed to the find item method as the parameters corresponding to the elements in the web services request. For example, the item shape element of the web services request corresponds to the item shape parameter of the find item method. The item shape element of the web services request is passed to the find items method as the item shape parameter of the find item method. Furthermore, the indexed page view element, the fractional page item view element, the calendar view element, and the contacts view elements of the web services request correspond to a view parameter of the find item method. The XML schema only permits the web services request to include one of these elements. The one of these elements included in the web services request is passed to the find item method as the view parameter of the find item method.

In response to receiving the web services request, the web services API 114 uses the indexing service 112 of the content server 106 to identify responsive content items that the user identified by the identification token is authorized to access (308). The responsive content items are ones of the content items 110 that are in the folders specified by the web services request, and that satisfy the one or more query conditions specified by the web services request. In some embodiments, the web services API 114 temporarily caches the responsive content items when the responsive content items are to be displayed in a plurality of separate pages.

In various embodiments, the web services API 114 uses the indexing service 112 to identify the responsive content items in various ways. For example, in some embodiments, the web services API 114 uses the indexing service 112 to identify the responsive content items by using a shell script to send commands to the indexing service 112. Furthermore, in some embodiments, the web services API 114 uses the indexing service 112 to identify the responsive content items by invoking one or more methods of a Message Application Programming Interface (MAPI) provided by the content server 106. Furthermore, in some embodiments, the indexing service 112 implements a web services API. In such embodiments, the web services API 114 sends one or more web services requests to the web services API of the indexing service 112 to identify the responsive content items.

After using the indexing service 112 to identify the responsive content items that the user identified by the identification token is authorized to access, the web services API 114 generates a web services response (310). The web services response is responsive to the web services request. If there are any responsive content items in the folders identified by the web services request, the web services response comprises one or more properties of the responsive content items. The properties are specified by the item shape element of the web services request. In embodiments where the web services request specifies a view, the web services API 114 generates the web services response such that the responsive content items conform to the view. In embodiments where the web services request specifies a way of grouping responsive content items, the web services API 114 generates the web services response such that the responsive content items conform are grouped in the specified way. In embodiments where the web services request specifies a way in which to sort responsive content items, the web services API 114 generates the web services response such that the responsive content items are sorted in the specified way. After generating the web services response, the web services API 114 sends the web services response to the client 102 via the network 108 (312).

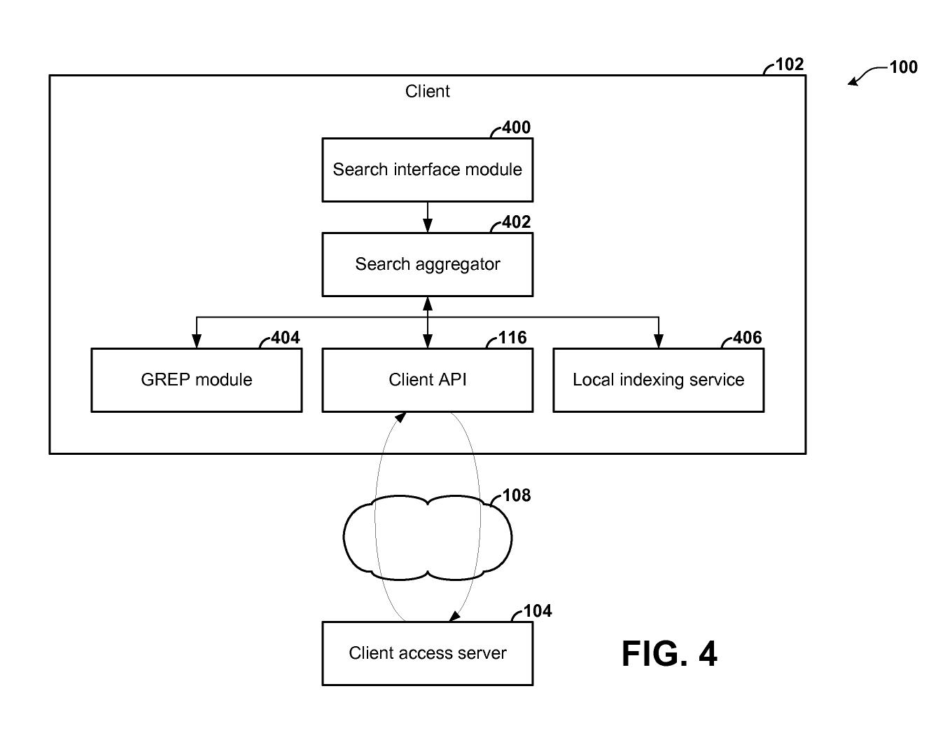

FIG. 4 is a block diagram illustrating a version of the system 100 in which the client 102 uses a federated search system to identify responsive content items. The system 100 illustrated in the example of FIG. 4 is merely one embodiment. Other embodiments include more or fewer computing devices, computing systems, networks, and other components.

As illustrated in the example of FIG. 4, the system 100 includes the client 102, the client access server 104, and the network 108. The content server 106 is omitted from FIG. 4 for purposes of clarity. The client access server 104, the network 108, and the content server 106 operate in the ways described above.

The client 102 includes a search interface module 400, a search aggregator 402, a GREP module 404, the client API 116, and a local indexing service 406. In various embodiments, the search interface module 400, the search aggregator 402, the GREP module 404, the client API 116, and the local indexing service 406 can be implemented in various ways. For example, in some embodiments, the search interface module 400, the search aggregator 402, the GREP module 404, the client API 116, and the local indexing service 406 are implemented as sets of software instructions that, when executed by a processing unit, cause the client to perform the activities ascribed herein to the search interface module 400, the search aggregator 402, the GREP module 404, the client API 116, and the local indexing service 406. In other embodiments, the client 102 includes one or more application-specific integrated circuits that cause the client 102 to perform the activities ascribed herein to the search interface module 400, the search aggregator 402, the GREP module 404, the client API 116, and the local indexing service 406.

In some embodiments, the search interface module 400 displays a graphical user interface. In various embodiments, the search interface module 400 displays various graphical user interfaces. For example, in some embodiments where the client 102 uses a Microsoft WINDOWS® operating system, the search interface module 400 displays a Windows desktop search user interface. In other embodiments, the search interface module 400 displays a search screen of an e-discovery application. A user of the client 102 uses the graphical user interface to provide input expressing one or more query conditions. For example, in some embodiments, the user uses the graphical user interface to provide input expressing an AQS query. In other embodiments, the user uses the graphical user interface to provide input expressing a search filter object.

In other embodiments, the client 102 is a server. In such embodiments, the search interface module 400 receives a request for a web page containing search results. The request for the web page includes one or more query conditions. For example, the request can include a URL containing a query string that expresses the one or more query conditions.

The search aggregator 402 acts as the client application 118 illustrated in FIG. 1. When the search interface module 400 receives the one or more query conditions, the search interface module 400 provides the one or more query conditions to the search aggregator 402. When the search aggregator 402 receives the one or more query conditions, the search aggregator 402 provides the query conditions to the GREP module 404, the client API 116, and the local indexing service 406. In some embodiments, the search aggregator 402 reformats the one or more query conditions prior to providing the one or more query conditions to the GREP module 404, the client API 116, and the local indexing service 406.

The GREP module 404, the client API 116, and the local indexing service 406 operate to identify responsive content items in different ways and/or in different repositories. For example, in some embodiments, the GREP module 404 uses regular expressions to identify files containing that satisfy the one or more query conditions, the client API 116 includes a method that operates to identify ones of the content items 110 that satisfy the one or more query conditions, and the local indexing service 406 uses a local index to identify locally stored content items that satisfy the one or more query conditions. The local index is an index of content items stored at the client 102.

After the GREP module 404, the client API 116, and the local indexing service 406 identify responsive content items, the GREP module 404, the client API 116, and the local indexing service 406 provide responses to the search aggregator 402. The responses identify the responsive content items. Upon receiving the responses from the GREP module 404, the client API 116, and the local indexing service 406, the search aggregator 402 aggregates the responsive content items into a single response and provides the response to the search interface module 400.

In various embodiments, the search interface module 400 performs various actions upon receiving the response from the search interface module 400. For example, in some embodiments, the search interface module 400 uses the response from the search aggregator 402 to display a user interface that specifies at least one property of the responsive content items. In other embodiments, the search interface module 400 uses the response from the search aggregator 402 to generate a web page that specifies at least one property of the responsive content items. The search interface module 400 then sends the web page to a client computing system that requested the web page.

The example of FIG. 4 illustrates the client 102 as including three search modules: the GREP module 404, the client API 116, and the local indexing service 406. Nevertheless, it should be understood that, in alternate embodiments, the client 102 can include more, fewer, or different search modules. For example, in one alternate embodiment, the client 102 includes an OpenSearch search module, a web search module, a FAST search module, a Microsoft SharePoint® search module, and/or other types of search modules.

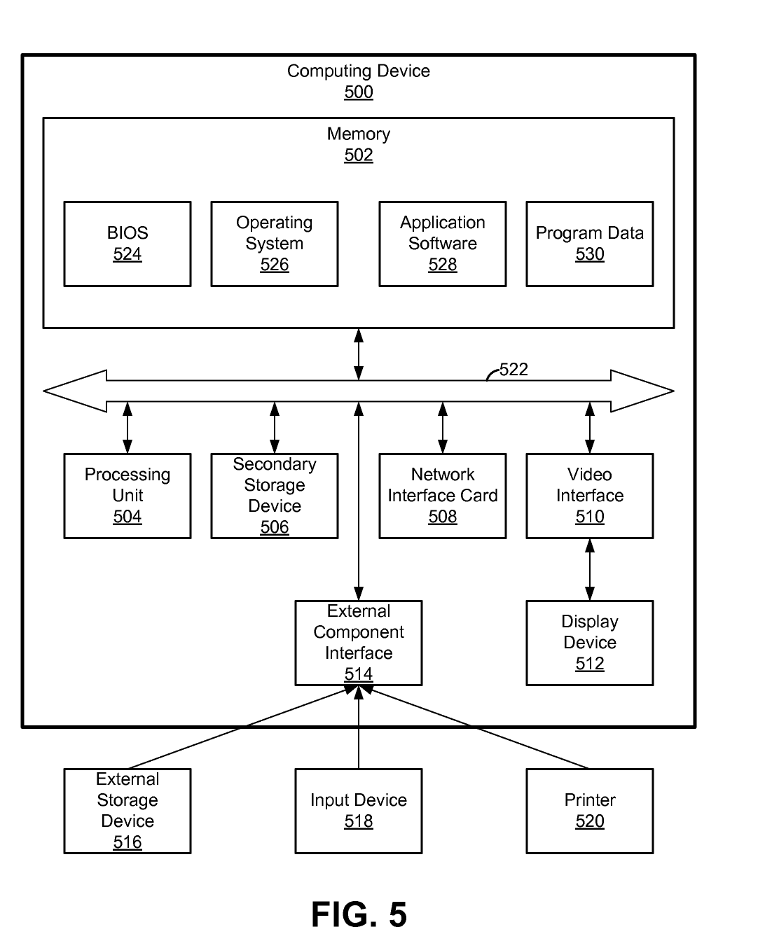

FIG. 5 is a block diagram illustrating an example computing device 500 usable in the system 100. In some embodiments, the client 102, the client access server 104, and the content server 106 are implemented using one or more computing devices like the computing device 500. It should be appreciated that in other embodiments, the client 102, the client access server 104, and the content server 106 are implemented using computing devices having hardware components other than those illustrated in the example of FIG. 5.

In different embodiments, computing devices are implemented in different ways. For instance, in the example of FIG. 5, the computing device 500 comprises a memory 502, a processing unit 504, a secondary storage device 506, a network interface card 508, a video interface 510, a display device 512, an external component interface 514, an external storage device 516, an input device 518, a printer 520, and a communication medium 522. In other embodiments, computing devices are implemented using more or fewer hardware components. For instance, in another example embodiment, a computing device does not include a video interface, a display device, an external storage device, or an input device.

The memory 502 includes one or more computer-readable data storage media capable of storing data and/or instructions. In different embodiments, the memory 502 is implemented in different ways. For instance, in various embodiments, the memory 502 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing unit 504 includes one or more physical integrated circuits that selectively execute software instructions. In various embodiments, the processing unit 504 is implemented in various ways. For instance, in one example embodiment, the processing unit 504 is implemented as one or more processing cores. For instance, in this example embodiment, the processing unit 504 may be implemented as one or more Intel Core 2 microprocessors. In another example embodiment, the processing unit 504 is implemented as one or more separate microprocessors. In yet another example embodiment, the processing unit 504 is implemented as an ASIC that provides specific functionality. In yet another example embodiment, the processing unit 504 provides specific functionality by using an ASIC and by executing software instructions.

In different embodiments, the processing unit 504 executes software instructions in different instruction sets. For instance, in various embodiments, the processing unit 504 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 506 includes one or more computer-readable data storage media. The secondary storage device 506 stores data and software instructions not directly accessible by the processing unit 504. In other words, the processing unit 504 performs an I/O operation to retrieve data and/or software instructions from the secondary storage device 506. In various embodiments, the secondary storage device 506 is implemented by various types of computer-readable data storage media. For instance, the secondary storage device 506 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 508 enables the computing device 500 to send data to and receive data from a computer communication network. In different embodiments, the network interface card 508 is implemented in different ways. For example, in various embodiments, the network interface card 508 is implemented as an Ethernet interface, a token-ring network interface, a fiber optic network interface, a wireless network interface (e.g., WiFi, WiMax, etc.), or another type of network interface.

The video interface 510 enables the computing device 500 to output video information to the display device 512. In different embodiments, the video interface 510 is implemented in different ways. For instance, in one example embodiment, the video interface 510 is integrated into a motherboard of the computing device 500. In another example embodiment, the video interface 510 is a video expansion card. Example types of video expansion cards include Radeon graphics cards manufactured by ATI Technologies, Inc. of Markham, Ontario, Geforce graphics cards manufactured by Nvidia Corporation of Santa Clara, Calif., and other types of graphics cards.

In various embodiments, the display device 512 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 510 communicates with the display device 512 in various ways. For instance, in various embodiments, the video interface 510 communicates with the display device 512 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 514 enables the computing device 500 to communicate with external devices. In various embodiments, the external component interface 514 is implemented in different ways. For instance, in one example embodiment, the external component interface 514 is a USB interface. In other example embodiments, the computing device 500 is a FireWire interface, a serial port interface, a parallel port interface, a PS/2 interface, and/or another type of interface that enables the computing device 500 to communicate with external components.

In different embodiments, the external component interface 514 enables the computing device 500 to communicate with different external components. For instance, in the example of FIG. 5, the external component interface 514 enables the computing device 500 to communicate with the external storage device 516, the input device 518, and the printer 520. In other embodiments, the external component interface 514 enables the computing device 500 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 500.

The external storage device 516 is an external component comprising one or more computer readable data storage media. Different implementations of the computing device 500 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 518 is an external component that provides user input to the computing device 500. Different implementations of the computing device 500 interface with different types of input devices. Example types of input devices include, but are not limited to, keyboards, mice, trackballs, stylus input devices, key pads, microphones, joysticks, touch-sensitive display screens, and other types of devices that provide user input to the computing device 500. The printer 520 is an external device that prints data to paper. Different implementations of the computing device 500 interface with different types of printers. Example types of printers include, but are not limited to laser printers, ink jet printers, photo printers, copy machines, fax machines, receipt printers, dot matrix printers, or other types of devices that print data to paper.

The communications medium 522 facilitates communication among the hardware components of the computing device 500. In different embodiments, the communications medium 522 facilitates communication among different components of the computing device 500. For instance, in the example of FIG. 5, the communications medium 522 facilitates communication among the memory 502, the processing unit 504, the secondary storage device 506, the network interface card 508, the video interface 510, and the external component interface 514. In different implementations of the computing device 500, the communications medium 522 is implemented in different ways. For instance, in different implementations of the computing device 500, the communications medium 522 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 502 stores various types of data and/or software instructions. For instance, in the example of FIG. 5, the memory 502 stores a Basic Input/Output System (BIOS) 524, an operating system 526, application software 528, and program data 530. The BIOS 524 includes a set of software instructions that, when executed by the processing unit 504, cause the computing device 500 to boot up. The operating system 526 includes a set of software instructions that, when executed by the processing unit 504, cause the computing device 500 to provide an operating system that coordinates the activities and sharing of resources of the computing device 500. Example types of operating systems include, but are not limited to, Microsoft Windows®, Linux, Unix, Apple OS X, Apple OS X iPhone, Palm webOS, Palm OS, Google Chrome OS, Google Android OS, and so on. The application software 528 includes a set of software instructions that, when executed by the processing unit 504, cause the computing device 500 to provide applications to a user of the computing device 500. The program data 530 is data generated and/or used by the application software 528.

The various embodiments described above are provided by way of illustration only and should not be construed as limiting. Those skilled in the art will readily recognize various modifications and changes that may be made without following the example embodiments and applications illustrated and described herein.

We claim:

1. A method comprising:
sending, by a computing system, a web services request to a server via a network,
the server providing a web services application programming interface (API) that includes a method that operates to identify responsive content items among a plurality of content items,
the plurality of content items being partitioned into a plurality of folders,
the plurality of folders being divided into a plurality of hierarchical sets of folders,
each of the hierarchical sets of folders associated with a different user in a plurality of users,
each of the content items being a set of properties representing personal information,
the web services request requesting invocation of the method,
the responsive content items being ones of the content items that satisfy a query condition and that are in a folder in the plurality of folders,
the web services request comprising an element that specifies the folder,
the web services request comprising an element that expresses the query condition, and
the web services request comprising an element that identifies requested ones of the properties of the content items to return,
receiving, by the computing system, a web services response from the server, the web services response specifying the requested ones of the properties of at least one of the responsive content items.

2. The method of claim 1,
wherein the method further comprises:
receiving an invocation of a method of a client API from a client application; and
returning a software object representing the at least one of the responsive content items to the client application; and
wherein the computing system sends the web services request to the server in response to receiving the invocation of the method.

3. The method of claim 2, wherein receiving the invocation of the method of the client API comprises receiving an Advanced Query Syntax (AQS) query string from the client application, the AQS query string expressing the query condition.

4. The method of claim 2, further comprising:
receiving, by the client application, input expressing the query condition;
sending, by the client application, requests to identify content items that satisfy the query condition to a plurality of search modules, the plurality of search modules including the client API;
receiving, by the client application, responses from the plurality of search modules, the responses identifying the content items that satisfy the query condition; and
aggregating, by the client application, the content items that satisfy the query condition into a single response.

5. The method of claim 2, wherein the client application assists in e-discovery by searching folders associated with the plurality of users.

6. The method of claim 1,
wherein the web services request is an extensible markup language (XML) document that conforms to one XML schema; and
wherein the web services response is an XML document that conforms to another XML schema.

7. The method of claim 1,
wherein the method further comprises: sending, by the computing system, an identification token to the web services API, the identification token identifying a user; and
wherein the web services response only includes ones of the responsive content items that the user is authorized to access.

8. The method of claim 7, wherein the identification token indicates that the computing system is acting as though the user was logged in to the computing system.

9. The method of claim 1, wherein the web services request further comprises:
an element that expresses how the responsive content items are to be formatted,
an element that expresses how the responsive content items are to be grouped,
an element that expresses an order in which to sort the responsive content items, and
an element that expresses whether to search for responsive content items in sub-folders of the folder.

10. A method comprising:
receiving, by a computing system, a web services request from a client computing system via a network,
the computing system providing a web services application programming interface (API) that includes a method;
the web services request requesting invocation of the method,
the web services request comprising an element that specifies a folder,
the web services request comprising an element that expresses a query condition, and
the web services request comprising an element that identifies requested properties of content items to return,
in response to receiving the web services request, using an indexing service to identify responsive content items among a plurality of content items,
each of the content items being a set of properties representing personal information,
the plurality of content items being partitioned into a plurality of folders that includes that specified folder,
the plurality of folders being partitioned into a plurality of hierarchical sets of folders,
each of the hierarchical sets of folders associated with a different user in a plurality of users,
the responsive content items being ones of the content items that satisfy the query condition and that are in the specified folder,
sending, by the computing system, a web services response to the client computing system, the web services response specifying the requested properties of at least one of the responsive content items.

11. The method of claim 10, wherein the query condition is expressed as an Advanced Query Syntax (AQS) query string.

12. The method of claim 10,
wherein the web services request is an extensible markup language (XML) document that conforms to one XML schema; and
wherein the web services response is an XML document that conforms to another XML schema.

13. The method of claim 10,
wherein the method further comprises: receiving, by the computing system, an identification token that identifies a user; and
wherein the web services response only includes ones of the responsive content items that the user is authorized to access.

14. The method of claim 13, wherein the identification token indicates that the client computing system is acting as though the user was logged in to the client computing system.

15. The method of claim 13,
wherein the identification token specifies that the user has an electronic discovery role; and
wherein users having the electronic discovery role are authorized to access ones of the content items in multiple ones of the hierarchical sets of folders.

16. The method of claim 13,
wherein the method further comprises: establishing, by the computing system, an authenticated session with the client computing system; and
wherein receiving the web services request comprises receives in the web services request via the authenticated session.

17. The method of claim 10, wherein the web services request further comprises:
an element that expresses a way in which the responsive content items are to be formatted,
an element that expresses a way in which the responsive content items are to be grouped,
an element that expresses an order in which the responsive content items are to be sorted, and
an element that expresses whether to search for responsive content items in sub-folders of the folder.

18. The method of claim 17, wherein the responsive content items are formatted in the way in which the responsive content items are to be formatted, are grouped in the way in which the responsive content items are to be grouped, and are ordered according to the order in which the responsive content items are to be sorted.

19. The method of claim 10, wherein using the indexing service to identify the responsive content items comprises invoking a method of a Message Application Programming Interface (MAPI) that identifies the responsive content items by searching an index to the plurality of content items.

20. A computer-readable data storage medium comprising software instructions that, when executed by a processing unit of a computing system, cause the computing system to:
receive, by a client application that assists in e-discovery by searching a plurality of folders, input expressing one or more query conditions;
receive an invocation of a method of a client application programming interface (API) from the client application;
send, in response to receiving the invocation of the method of the client API, a web services request to a server via a network,
the server providing a web services API that includes a method that operates to identify responsive content items among a plurality of content items,
the plurality of content items being partitioned into the plurality of folders,
the plurality of folders being divided into a plurality of hierarchical sets of folders,
each of the hierarchical sets of folders associated with a different user in a plurality of users,
each of the content items being a set of properties representing personal information,
the web services request requesting invocation of the method,
the responsive content items being ones of the content items that satisfy a query condition and that are in a folder in the plurality of folders,
the web services request comprising an element that specifies the folder,
the web services request comprising an element that expresses the one or more query conditions as an Advanced Query Syntax (AQS) query string,
the web services request comprising an element that identifies requested ones of the properties of the content items to return,
an element that expresses a way in which the responsive content items are to be formatted,
an element that expresses a way in which the responsive content items are to be grouped,
an element that expresses an order in which the responsive content items are to be sorted,
an element that expresses whether to search for responsive content items in sub-folders of the folder,
the web services request being an extensible markup language (XML) document that conforms to one XML schema;
send an identification token to the web services API, the identification token identifying a user;
receive a web services response from the server, the web services response specifying the requested ones of the properties of at least one of the responsive content items, wherein the web services response is an XML document that conforms to another XML schema, wherein the web services response only includes ones of the responsive content items that the user is authorized to access; and
return a software object representing the at least one of the responsive content items to the client application.
